(19) United States
(12) Patent Application Publication
(10) Pub. No.: US 2016/0144207 A1
(43) Pub. Date: May 26, 2016

(54) WATER TANK FALL ARREST AND RESCUE APPARATUS

(71) Applicant: Western Technology Services International, Inc., Casper, WY (US)

(72) Inventors: Frederick J. Reynolds, Casper, WY (US); Scott Taylor, Casper, WY (US); Justin Dykes, Casper, WY (US); Tyrell Marlow, Evansville, WY (US)

(73) Assignee: WESTERN TECHNOLOGY SERVICES INTERNATIONAL, INC., Casper, WY (US)

(21) Appl. No.: 14/947,648

(22) Filed: Nov. 20, 2015

Related U.S. Application Data
(60) Provisional application No. 62/084,044, filed on Nov. 25, 2014.

(51) Int. Cl. A62B 35/00

(52) U.S. Cl. CPC A62B 35/0006; A62B 35/0093; A62B 35/0068

(57) ABSTRACT

A water tank fitted with a fall arrest assembly, a rescue device, and a rescue kit. The fall arrest assembly provides a safe means for personnel to perform inspection and maintenance activities on top of a water tank. The rescue device and rescue kit provide a safe and expeditious means to perform rescue activities in case of an emergency either inside or on top of a water tank. The water tank thus takes into consideration the safety of both the patient and the rescuers with the use of the fall arrest assembly and rescue device and rescue kit.

### CROSS-REFERENCE TO RELATED APPLICATION

This application claims the benefit of the filing date of U.S. Provisional Patent Application Ser. No. 62/084,044, filed 25 Nov. 2014, for “Water Tank Fall and Arrest System,” the disclosure of which is hereby incorporated herein in its entirety by this reference.

### BACKGROUND

This disclosure relates to a transportable water tank having a fall arrest and rescue apparatus incorporated into the top of the water tank. In particular, the disclosure includes the use of a fall arrest cable tie-off assembly, a rescue kit, and a davit arm device that are all self-contained by the water tank for ease of accessibility.

Keeping mobile equipment operational is a major concern for many industries. For example, in the mining industry, the general construction industry, and the highway construction industry, the operational availability of this equipment is crucial to the success of the business. One piece of equipment often used in these industries is a water tanker. The water tanker is used to spray water onto the surface soil to control dust and prevent dust from drifting to surrounding areas.

The safety of the personnel responsible for maximizing the operational availability of the water tanker is important. At times, personnel may access the top of a water tank, for example, to access various components, such as water cannons, spray valves and lights, or to conduct an inspection of the tank and its components. Some of these components may be close to the edge of the top of the tank. The top of a water tank mounted to a truck chassis may be 15 feet to 30 feet above ground level, depending on the size of the vehicle and the tank capacity. Falls from these heights could cause serious bodily injury or even death.

Another aspect of the inspection and maintenance activities that must be taken into consideration is how to rescue personnel should an emergency occur while people are inside of, or on top of, the water tank. Rescue plans describing how to extract a person from the top or from the inside of a tank in the event of an emergency may exist, but these plans may neglect to identify a safe and expeditious means of getting an injured person from the top of the tank to the ground and into the care of advanced medical personnel.

### SUMMARY

The present disclosure provides a water tank safety system that overcomes many of the shortcomings of prior designs. The present system includes various features. For example, personnel may attach the lanyard of their safety harness to a fall arrest tie-off assembly. The fall arrest tie-off assembly allows personnel to access all areas on top of the tank and is designed to prevent a fall beyond the length of the harness lanyard.

The safety system may also include a rescue kit secured to the top of the water tank for easy access by rescue personnel in an emergency. The rescue kit contains various items required to conduct a proper rescue. These items are used to rescue a person from the interior of the tank and to lower the patient from the top of the tank to the ground. The items include, but are not limited to, a self-braking descender, steel carabiners, a rope grab, a short haul pulley, anchor straps, and rope. The items are typically stored in a water-proof storage bag.

The water tank safety system may include a rescue device comprised of a davit arm, a davit arm base and fall arrest tie-offs. The davit arm is stored on top of the tank near the rescue kit. The davit arm is inserted into a davit arm base that is mounted to a davit arm mount bracket. The mount bracket is permanently attached to the top of the water tank. The davit arm utilizes various components in the rescue kit and is used to lower a patient from the top of the water tank to the ground.

### BRIEF DESCRIPTION OF THE DRAWINGS

Other features and advantages of the present disclosure will be apparent from reference to the following Detailed Description taken in conjunction with the accompanying Drawings, in which:

FIG. 1 depicts a side elevation view of a water tank on a vehicle chassis;

FIG. 2 depicts a front isometric view of a water tank with the safety system installed thereon;

FIG. 3 depicts an isometric view of a shuttle sliding over cable and system anchor components of the fall arrest assembly;

FIG. 4 depicts a cross-sectional view of the shuttle sliding over the cable and system anchor components of the fall arrest assembly;

FIGS. 5A, 5B, and 5C depict perspective views of elements of the cable and anchor components of FIG. 2; and

FIG. 6 depicts a perspective view of a rescue device.

### DETAILED DESCRIPTION

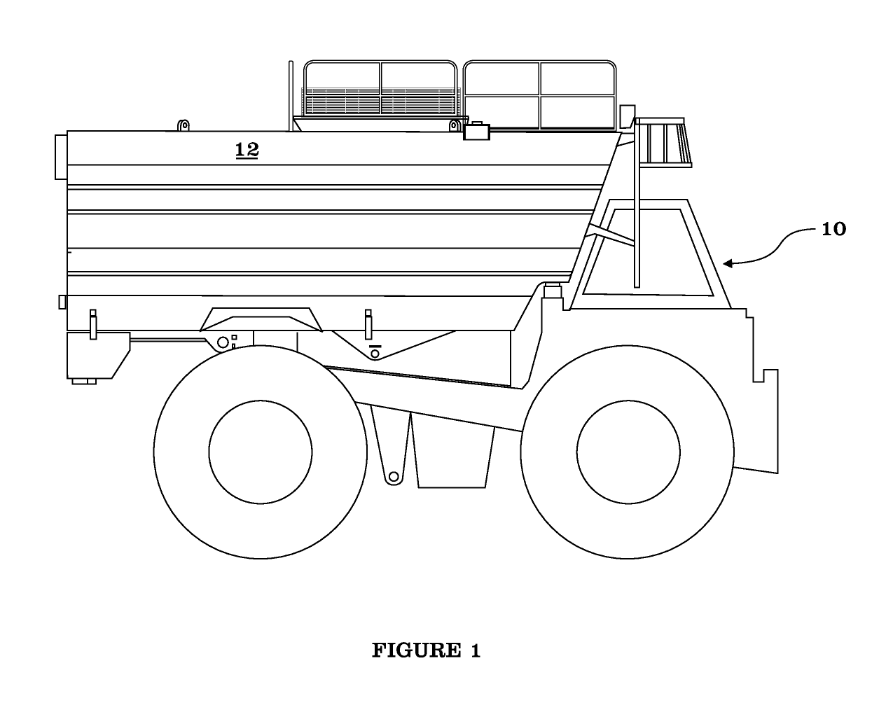

FIG. 1 depicts a representative vehicle 10 for carrying a water tank 12. The configuration shown is typical of a water tanker truck used in the mining industry for dust suppression and fire control. However, the water tank 12 may be attached to other types of vehicles 10 such as on-highway vehicles, trailers, or the like. Those skilled in the art will appreciate that the tank 12 may be constructed with various physical dimensions to accommodate the various sized vehicles 10 on which the tank 12 may be mounted.

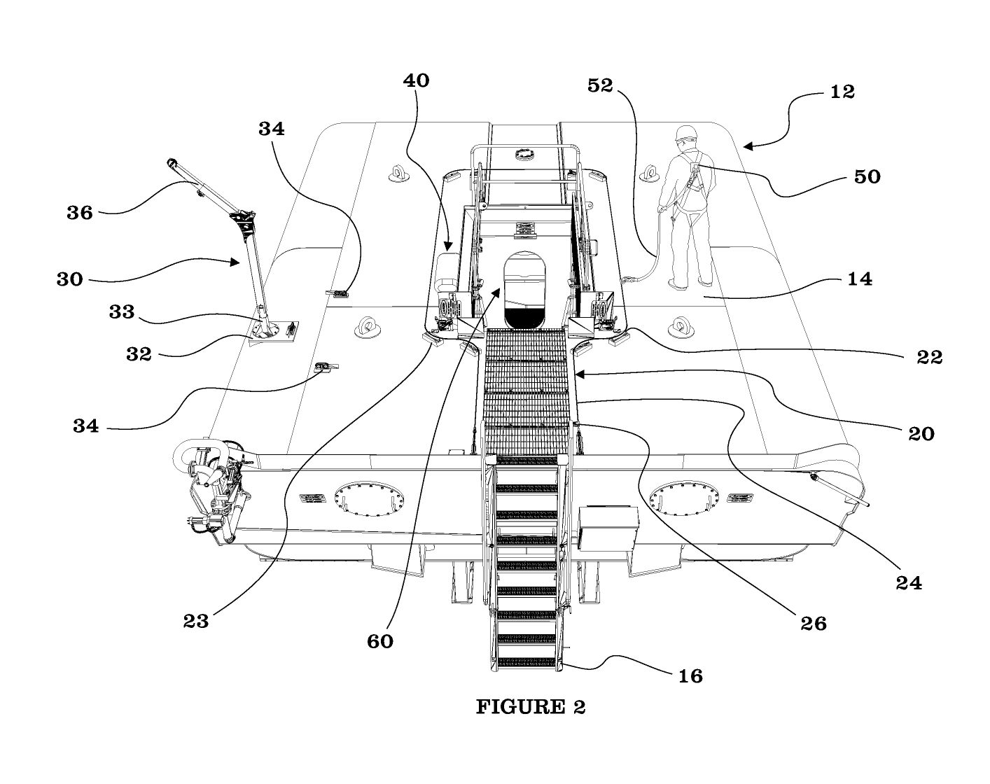

FIG. 2 depicts a representative water tank 12 on which a fall arrest assembly 20, a rescue device 30 and a rescue kit 40 are installed according to the present disclosure. The configuration shown is typical of a water tank 12 used in the mining industry for dust suppression and fire control. The water tank 12 includes a top 14 on which the fall arrest assembly 20, rescue device 30 and rescue kit 40 are attached, as well as a ladder 16 that provides access from the vehicle 10 deck to the top 14 of the water tank 12. In some embodiments, the top 14 of the water tank 12 may also be accessed from the vehicle 10 deck by other devices such as a stairway. Those skilled in the art will appreciate that the fall arrest assembly 20 and rescue device 30 of the present disclosure may be constructed with various physical dimensions and configurations to accommodate the various sized water tanks 12, or other devices on which the fall arrest assembly 20, rescue device 30, and rescue kit 40 may be installed.

Typically, the fall arrest assembly 20 is installed on the top 14 of the water tank 12 during manufacturing of the water tank 12. However, the fall arrest assembly 20, the rescue device 30 and the rescue kit 40 need not be installed during the manufacture of the water tank 12 but may also be retro-fitted to an existing water tank 12. The fall arrest assembly 20 includes several anchors 22 mounted on mounting blocks 23, a plurality of which are affixed around the top 14 of the water tank 12. A safety cable 24 is routed through a loop or eyelet formed in the top of each of the anchors 22 and the cable 24 is put into tension, typically the tension suggested by the manufacturer, as will be understood by one of skill in the art. The fall arrest assembly 20 may fashioned from elements offered in the industry; the embodiment depicted relies heavily on the Skyline Horizontal Anchor Device offered by Skylotec GmbH of Neuwied, Germany.

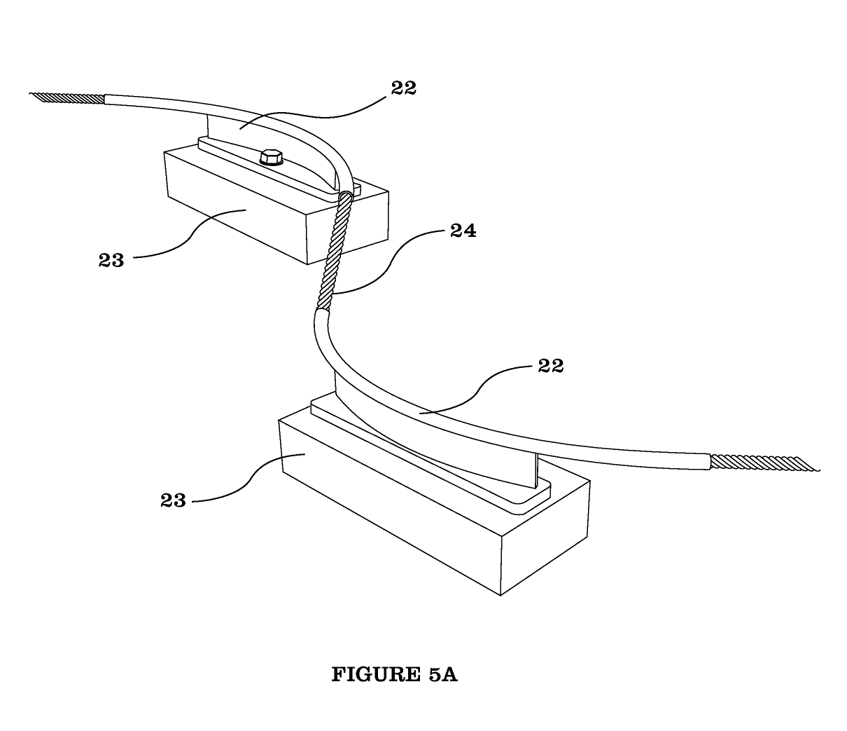

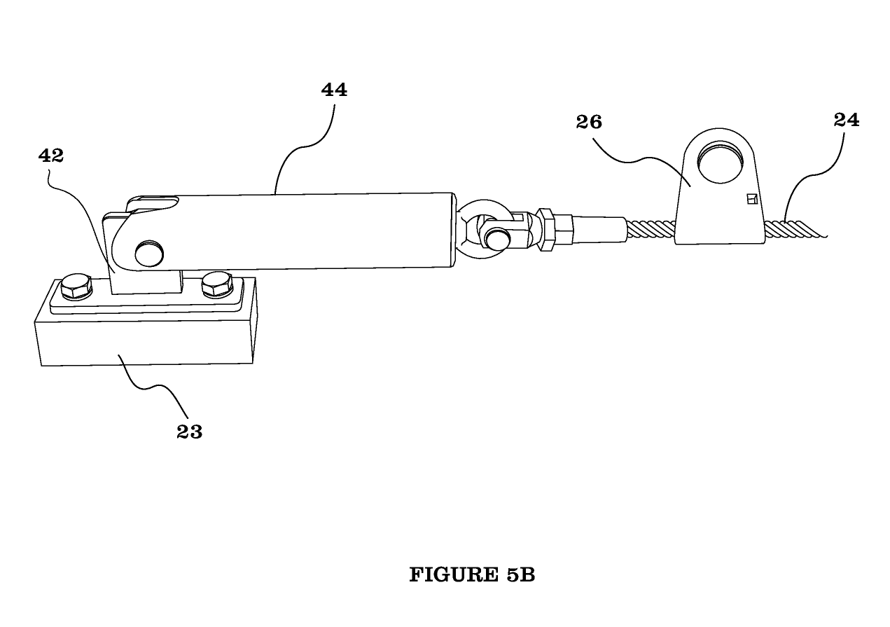

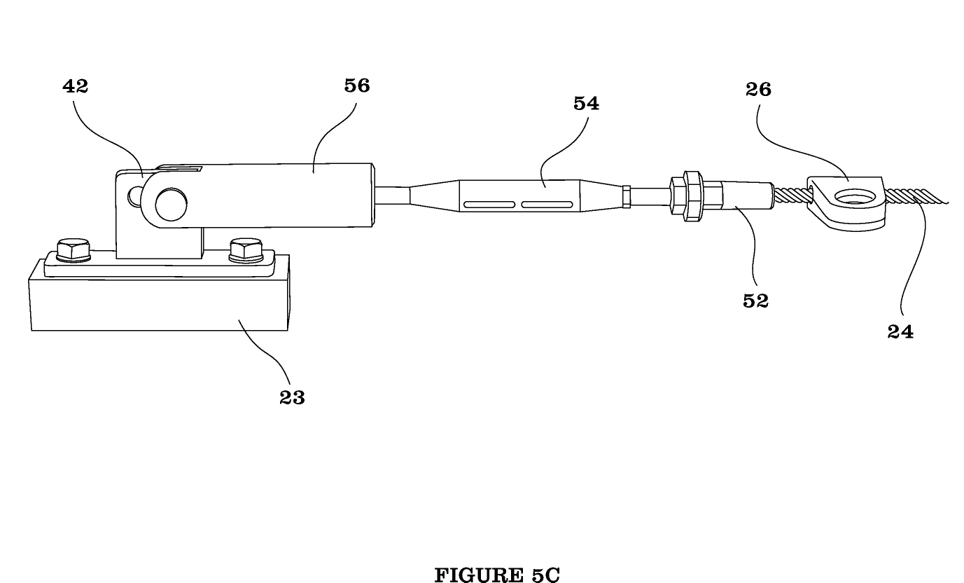

FIG. 5A depicts two anchors 22, one curving in one direction and the other in the opposite direction. This opposite curvature permits the cable 24 to be curved around the top 14 of the water tank 12. As a result, the entire upper surface 14 of the water tank 12 may be visited by a worker without removing the worker's lanyard 52 from the shuttle 26.

FIG. 5B depicts a termination anchor 42 on a mounting block 23. In the embodiment depicted in FIG. 5B, a compensator 44 affixed to the termination anchor 42 includes an integrated eye bolt to which a first end of the cable 24 is attached. The compensator 44 provides a certain degree of shock absorption to compensate for tension in the cable 24. If the compensator 44 undergoes tension beyond a certain point (typically set by the manufacturer during manufacture of the compensator), the eye bolt over-extends, providing visual evidence to notify users that the cable 24 has been stretched too far, and the compensator 44 needs to be replaced.

FIG. 5C depicts another termination anchor 42 on a mounting block 23. In the embodiment depicted in FIG. 5C, the second end of the cable 24 is attached to a wire rope thimble 52. The thimble 52 connects to a turnbuckle 54 which in turn connects to a tension indicator 56. The turnbuckle 54 may be used to increase or decrease the tension in the cable 24, as indicated by the tension indicator 56.

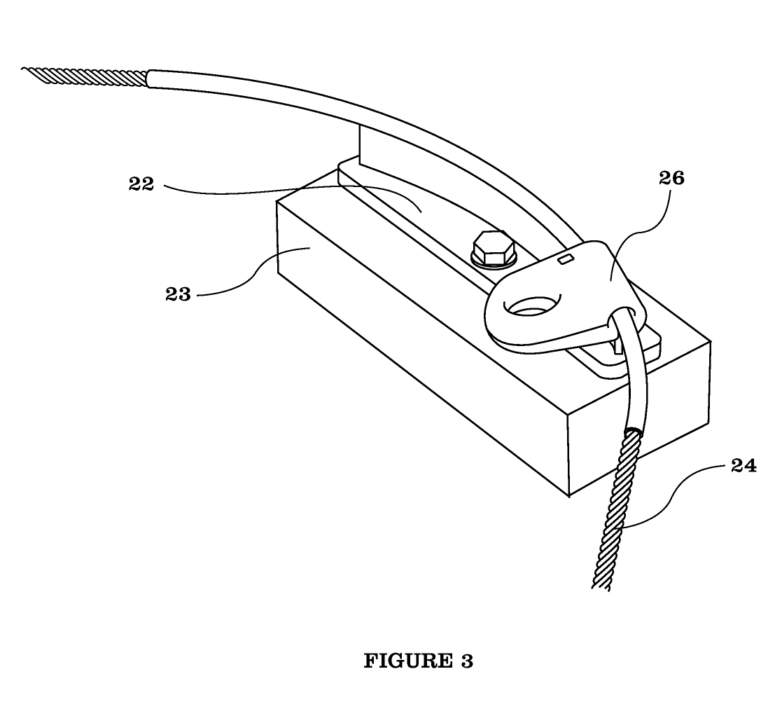

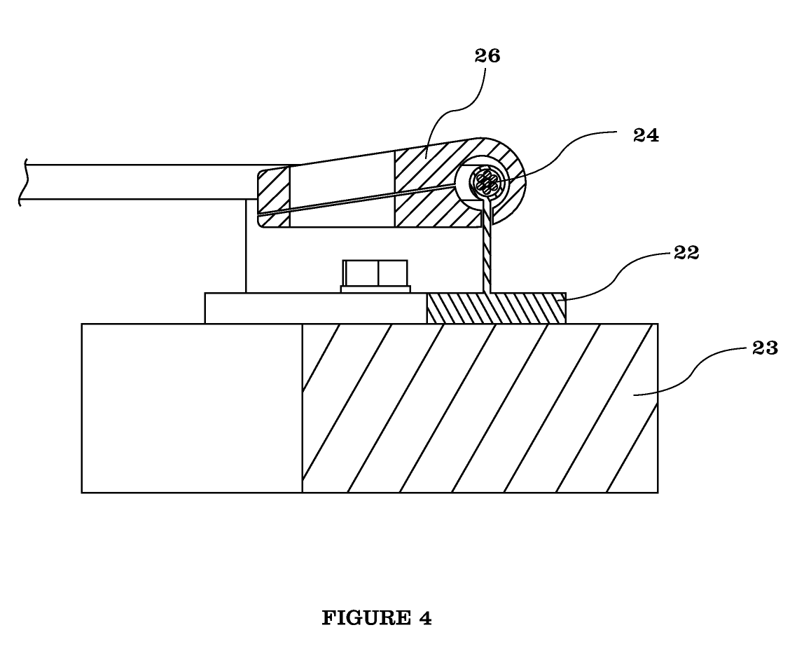

Prior to accessing the top 14 of the water tank 12, personnel put on an OSHA, ANSI, CSA, or other approved safety harness 50. A shuttle 26 (see FIGS. 3 and 4) is attached to the safety cable 24 of the fall arrest assembly 20. When personnel access the top 14 of the water tank 12, the personnel attach a lanyard 52 from the safety harness 50 to the shuttle 26. Personnel may then access the entire top 14 of the water tank 12 to perform inspection or maintenance tasks while attached to the fall arrest assembly 20.

In the embodiment depicted in FIG. 2, personnel may also access an entry point 60 into the water tank 12 while being attached to the fall arrest assembly 20. Once at the entry point 60 on the top 14 of the water tank 12, personnel may detach the lanyard 52 from the shuttle 26 and access the interior of the water tank 12 to perform inspection, maintenance and cleaning functions. All personnel must follow approved entry procedures specific to the location prior to entering the water tank 12. The approved entry procedure will vary from site to site based on the governing safety regulations. Although FIG. 2 depicts an entry point 60 for the Westech Stairway Access Tank (this tank is the subject of U.S. patent application Ser. No. 14/345,726 filed Mar. 19, 2014, the disclosure of which is incorporated herein in its entirety by this reference), different embodiments of the water tank 12 may have other entry point 60 configurations.

FIG. 3 depicts one embodiment of a shuttle 26 and illustrates how the shuttle 26, when attached to the cable 24 of the fall arrest assembly 20, slides along the cable 24 and the anchors 22. The cable 24 is routed through each of the anchors 22 of the fall arrest assembly 20. The inside diameter of the shuttle 26 is large enough so as to be able to slide over the anchors 22 through which the cable 24 is routed. Typically, the shuttle 26 has a locking mechanism that secures the shuttle 26 around the cable 24 and prevents the shuttle 26 from accidentally detaching from the cable 24.

FIG. 4 is a cross-sectional view of one of the anchors 22 and the shuttle 26 depicted in FIG. 3. FIG. 4 depicts how the cable 24 is routed through the anchors 22. FIG. 4 also depicts the clearance between the shuttle 26 and both the cable 24 and the anchor 22 that allows the shuttle 26 to freely slide around on the fall arrest assembly 20. It will appreciated by those skilled in the art that the shuttle 26 and anchors 22 may have different configurations in different embodiments, all of which would meet the functionality requirements of the fall arrest assembly 20.

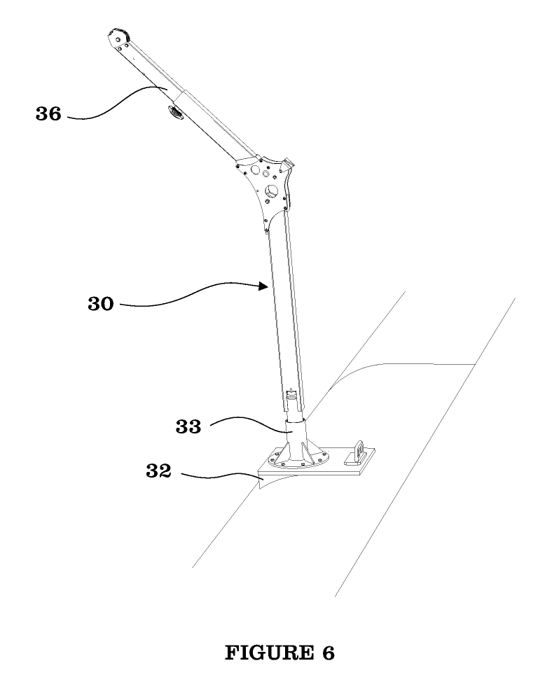

During the manufacture of the water tank 12, a rescue device 30, as depicted by the embodiment shown in FIG. 2, may be installed on the top 14 of the water tank 12. As depicted in perhaps more detail in FIG. 6, the rescue device 30 includes a davit arm mount bracket 32 permanently attached to the top 14 of the water tank 10. A davit arm base 33 mounts to the mount bracket 32. Fall arrest tie-offs 34 are also permanently attached to the top 14 of the water tank 12. A davit arm 36 is stored on top 14 of the water tank 12 for ease of access in the case of an emergency that would require a person to be lowered off the top 14 of the water tank 12 to the ground. As depicted in FIG. 2, the davit arm 36 is mounted on the davit arm base 33 when in use.

A rescue kit 40 may be stored on top 14 of the water tank 12 for ease of access in case of an emergency. The rescue kit 40 contains various pieces of equipment necessary or useful to perform a rescue from the water tank 12. The equipment includes, but is not limited to, a self-braking descender, steel carabiners, a rope grab, a short haul pulley, anchor straps, and rope. The required equipment in each rescue kit 40 may be determined by the rescue team personnel responsible for conducting rescue activities.

In the event of an emergency where an individual is injured in the interior of the water tank 12, rescue personnel will utilize the fall arrest assembly 20, the rescue device 30 and the equipment in the rescue kit 40 to perform a rescue. In a typical rescue scenario, a four person rescue team would arrive at the scene, assess the situation and suit-up with the necessary personal protection equipment (“PPE”). The PPE would typically include, but not be limited to, a safety harness 50 with lanyard 52, safety glasses, hard hat, gloves, safety boots and air respirators as required. Two members of the rescue team are typically designated as the entry team and the other two members are typically designated as the exterior team.

In the embodiment depicted in FIG. 2, the rescue team members would use the ladder 16 (or other alternative means, such as a staircase or a hydraulic man-lift) to access the top 14 of the water tank 12. The entry team members would gather required equipment out of the rescue kit 40 to conduct the rescue from the interior of the water tank 12. While the entry team performed the required actions to get the survivor to the top 14 of the water tank 12, the exterior team members would attach their lanyards 52 to the fall arrest tie-offs 34 to ensure their safety during the rescue process. The exterior team would place the davit arm 36 into the davit arm base 32. The davit arm 36 would then be rigged with the proper equipment, such as rope, carabiners and a self-braking descender from the rescue kit 40.

Once the entry team got the survivor to the top 14 of the water tank 12, the entry team members would also attach their lanyards 52 to shuttles 26 on the fall arrest assembly 20 or the fall arrest tie-offs 34 to ensure their safety during the rescue process. If the survivor was wearing a safety harness 50, then the survivor's safety harness 50 would be directly attached to the davit arm 36 of the rescue device 30. The survivor would be raised off the top 12 of the water tank 12 and the davit arm 36 would be rotated out over the side of the water tank 12. Once clear of the side of the water tank 12, the survivor would be lowered to the ground and into the care of advanced medical personnel. It will be appreciated that other rescue equipment, such as a rescue basket, could be used with the rescue device 30 to lower the survivor from the top 14 of the water tank 12 to the ground depending on the situation.

Although particular embodiments of the present invention have been described, those of skill in the art will appreciate that various modifications and changes may be made by those skilled in the art without departing from the spirit and scope of the invention. The present invention may be embodied in other specific forms without departing from its structures, methods, or other essential characteristics as broadly described herein and claimed hereinafter. The described embodiments are to be considered in all respects only as illustrative, and not restrictive.

1. An apparatus for industrial and mining operations comprising:
a water tank having an upper surface, the water tank having dimensions sufficient to permit personnel to walk over the upper surface;
a fall arrest assembly mounted on the upper surface of the water tank, the fall arrest assembly comprising:
a cable having a predetermined length and a first end and a second end, the first end of the cable being mounted to the upper surface by a compensator attached to a first termination anchor and the second end of the cable being mounted to the upper surface by a tension indicator attached to a second termination anchor;
a plurality of anchors affixed to the upper surface and supporting the cable between the first and second end of the cable, the anchors having integral loops through which the cable passes to hold the cable, the anchors thereby permitting the cable to be extended across a predetermined portion of the upper surface of the water tank;
at least one shuttle attached to the safety cable and capable of sliding along the length of the cable, each shuttle having a slot formed therein to permit the shuttle to pass over each of the anchors and each shuttle having a lanyard connection so that personnel walking on the upper surface of the water tank may detachably connect a first end of a lanyard to the shuttle and detachably connect a second end of the lanyard to a safety harness worn by the personnel, the lanyard thereby able to act as a safety line to prevent the personnel from falling off of the water tank when the lanyard is connected to the shuttle and the harness;
a rescue device mounted to the water tank, the rescue device comprising:
a davit arm mount bracket permanently attached to the water tank; and
a davit arm removably mountable to the davit arm mount bracket;
fall arrest tie-offs permanently mounted to the water tank; and
a rescue kit stored on the upper surface of the water tank for ease of access in case of an emergency.

2. The apparatus of claim 1 in which the rescue kit comprises at least one of:
a self-braking descender,
at least one steel carabiner;
a rope grab;
a short haul pulley,
anchor straps; and
a length of rope; and
personal protection equipment comprising at least one of:
a safety harness;
a lanyard;
safety glasses;
a hard hat;
gloves;
safety boots; and
an air respirator.

3. The apparatus of claim 1 further comprising a safety harness and a lanyard.

4. An apparatus for industrial and mining operations comprising:
a water tank having an upper surface, the water tank having dimensions sufficient to permit personnel to walk over the upper surface;
a fall arrest assembly mounted on the upper outer surface of the water tank; and
a rescue device mounted to the water tank.

5. The apparatus of claim 4 wherein the fall arrest assembly comprises:
a cable having a predetermined length and a first end and a second end;
a plurality of anchors affixed to the upper surface and supporting the cable between the first and second end of the cable, the anchors thereby permitting the cable to be extended across a predetermined portion of the upper surface of the water tank; and
at least one shuttle attached to the safety cable and capable of sliding along the length of the cable.

6. The apparatus of claim 5 wherein the first end of the cable is mounted to the upper surface by a compensator attached to a first termination anchor.

7. The apparatus of claim 5 wherein the second end of the cable is mounted to the upper surface by a tension indicator attached to a second termination anchor.

8. The apparatus of claim 5 wherein the anchors have integral loops through which the cable passes to hold the cable to the anchors.

9. The apparatus of claim 5 wherein each shuttle has a slot formed therein to permit the shuttle to pass over each of the anchors.

10. The apparatus of claim 5 wherein each shuttle has a lanyard connection so that personnel walking on the upper surface of the water tank may detachably connect a first end of a lanyard to each shuttle and detachably connect a second end of the lanyard to a safety harness worn by the personnel, the lanyard thereby able to act as a safety line to prevent the personnel from falling off of the water tank when the lanyard is connected to each shuttle and the harness.

11. The apparatus of claim 4 wherein the rescue device comprises:
a davit arm mount bracket permanently attached to the water tank; and
a davit arm removably mountable to the davit arm mount bracket.

12. The apparatus of claim 4 further comprising fall arrest tie-offs permanently mounted to the upper surface of the water tank.

13. The apparatus of claim 4 further comprising a rescue kit stored on the upper surface of the water tank for ease of access in case of an emergency.

14. The apparatus of claim 13 in which the rescue kit comprises at least one of:
a self-braking descender,
at least one steel carabiner;
a rope grab;
a short haul pulley,
anchor straps; and
a length of rope; and
personal protection equipment comprising at least one of:
a safety harness;
a lanyard;
safety glasses;
a hard hat;
gloves;
safety boots; and
an air respirator.

15. The apparatus of claim 4 further comprising a safety harness and a lanyard.
